(19) United States
(12) Patent Application Publication
(10) Pub. No.: US 2008/0019075 A1
(43) Pub. Date: Jan. 24, 2008

(54) DIELECTRIC CAPACITOR

(75) Inventors: Tatsuo SAWASAKI, Fujimi (JP); Yukio KITAHARA, Suwa (JP); Yukihiro IWASAKI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/780,005

(22) Filed: Jul. 19, 2007

(30) Foreign Application Priority Data
Jul. 20, 2006 (JP) 2006-198502

(51) Int. Cl. H01G 4/30

(52) U.S. Cl. 361/301.4

(57) ABSTRACT

A dielectric capacitor includes: a TiAlN film formed on a base substrate; a first electrode formed above the TiAlN film; a dielectric film formed above the first electrode; and a second electrode formed above the dielectric film, wherein the TiAlN film is crystalline, and has a (200) plane preferentially oriented in parallel with a surface of the base substrate.

The entire disclosure of Japanese Patent Application No. 2006-198502, filed Jul. 20, 2006 is expressly incorporated by reference herein.

### BACKGROUND

1. Technical Field

The present invention relates to dielectric capacitors.

2. Related Art

As progress has been made in the thin film forming technology in recent years, high permittivity characteristics of oxide dielectric thin film materials are applied to capacitors of semiconductor memory devices such as DRAMs, thereby attempting to further miniaturize the devices and increase the level of integration of the devices. Also, through application of their ferroelectric characteristics to capacitors, novel devices, such as, ferroelectric memories (hereafter referred to as FeRAM) that are capable of higher level of integration and higher operation speed are being developed.

However, despite the high potential of ferroelectric materials and their long history of development, FeRAMs still remain to be used in products with a lower level of integration, in other words, only products with a large capacitor size are commercialized. One of the reasons is that, as the size of a ferroelectric capacitor becomes smaller, the amount of signal charge retained in the capacitor reduces, and thus its output voltage is lowered. For this reason, the amount of remanent polarization of a capacitor may be increased to a higher level, which is an effective measure to achieve a higher level of integration of a FeRAM. In this connection, Japanese Laid-open Patent Application JP-A-2001-244426 is an example of related art.

### SUMMARY

In accordance with an advantage of some aspects of the present invention, it is possible to provide a dielectric capacitor that is capable of improving its remanent polarization value.

A dielectric capacitor in accordance with an embodiment of the invention includes: a TiAlN film formed on a base substrate; a first electrode formed above the TiAlN film; a dielectric film formed above the first electrode; and a second electrode formed above the dielectric film, wherein the TiAlN film is crystalline, and has a (200) plane preferentially oriented in parallel with a surface of the base substrate.

In the dielectric capacitor in accordance with an aspect of the embodiment of the invention, the dielectric film may have a perovskite type crystal structure, and may be preferentially oriented in a (111) plane.

In the dielectric capacitor in accordance with an aspect of the embodiment of the invention, the dielectric layer is composed of dielectric that may be expressed by a general formula of AB_{1-X} C_{X} O₃, where the element A is at least Pb, the element B may be composed of at least one of Zr, Ti, V, W and Hf, and the element C may be composed of at least one of La, Sr, Ca and Nb.

In the dielectric capacitor in accordance with an aspect of the embodiment of the invention, the dielectric film may be composed of lead zirconate titanate.

In the dielectric capacitor in accordance with an aspect of the embodiment of the invention, the dielectric film may be composed of lead zirconate titanate with at least one of La, Sr, Ca and Nb added therein.

In the dielectric capacitor in accordance with an aspect of the embodiment of the invention, the topmost layer of the first electrode may have a face-centered cubic type crystal structure and may be preferentially oriented in a (111) plane.

In the dielectric capacitor in accordance with an aspect of the embodiment of the invention, the conductive film may have a (100) plane that is not in parallel with a surface of the base substrate, wherein the (100) plane may be exposed at an interface between the first electrode and the dielectric.

In the dielectric capacitor in accordance with an aspect of the embodiment of the invention, the (100) plane of the conductive film may be lattice-matched to a (001) plane of the dielectric film.

In the dielectric capacitor in accordance with an aspect of the embodiment of the invention, the first electrode may include a conductive film composed of at least one of iridium, iridium oxide and platinum.

In the dielectric capacitor in accordance with an aspect of the embodiment of the invention, the first electrode may include an iridium film formed on the TiAlN film, an iridium oxide film formed on the iridium film, and a platinum film formed on the iridium oxide film.

### BRIEF DESCRIPTION OF THE DRAWINGS

FIG. 1 is a cross-sectional view schematically showing a dielectric capacitor in accordance with an embodiment of the invention.

FIG. 2 is a figure for describing the crystal structure of a first electrode in accordance with the present embodiment.

FIG. 3 is a figure for describing the crystal structure of the first electrode in accordance with the present embodiment.

FIG. 4 is a figure for describing the interface between a first electrode and a dielectric film in accordance with the present embodiment.

FIG. 5 is a cross-sectional view schematically showing a dielectric capacitor in accordance with an embodiment of the invention.

FIG. 6 is an AFM image showing the surface condition of a first electrode 20 in accordance with an experimental example 1.

FIG. 7 is a graph showing an XRD diffraction pattern of the first electrode 20 of the experimental example 1.

FIG. 8 is an AFM image showing the surface condition of a first electrode 20 in accordance with an experimental example 3.

FIG. 9 is a graph showing an XRD diffraction pattern of the first electrode 20 of the experimental example 3.

FIG. 10 is a graph showing an XRD diffraction pattern of a PZT film in accordance with the experimental example 1.

FIG. 11 is a graph showing an XRD diffraction pattern of a PZT film in accordance with an experimental example 2.

FIG. 12 is a graph showing an XRD diffraction pattern of a PZT film in accordance with the experimental example 3.

FIG. 13 is a graph showing the relation between the degree of orientation of a (111) plane of a PZT film and its value of remanent polarization.

FIG. 14 is a view showing the atomic arrangement at an interface between the first platinum film 26 and the PZT film 30 in accordance with the first experimental example 1.

FIG. 15A is a schematic cross-sectional view showing a step in a method for manufacturing a ferroelectric memory in accordance with an embodiment of the invention, and FIG. 15B is a schematic cross-sectional view showing a step of the method for manufacturing a ferroelectric memory in accordance with the embodiment of the invention.

### DESCRIPTION OF EXEMPLARY EMBODIMENTS

Preferred embodiments of the invention are described below with reference to the accompanying drawings.

### 1. DIELECTRIC CAPACITOR AND ITS MANUFACTURING METHOD

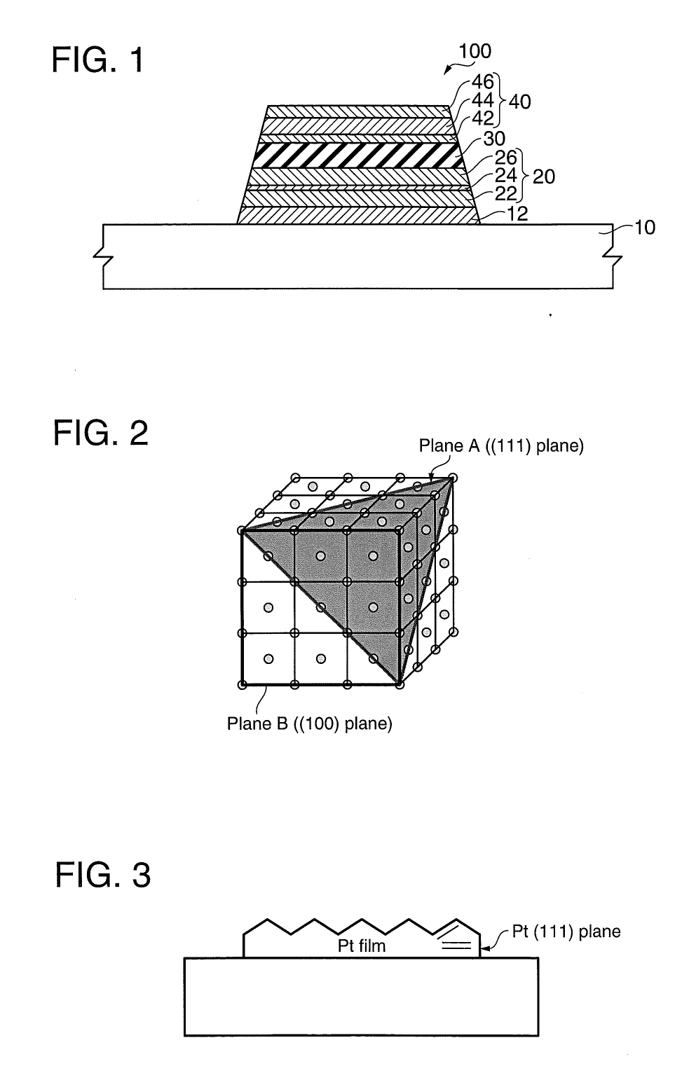

FIG. 1 is a cross-sectional view schematically showing a dielectric capacitor 100 in accordance with an embodiment of the invention. The dielectric capacitor 100 includes a base substrate 10, a TiAlN film 12, a first electrode 20, a dielectric film 30, and a second electrode 40. The first electrode 20 includes a first iridium film 22, a first iridium oxide film 24 and a first platinum film 26. Also, the second electrode 40 includes a first platinum film 42, a second iridium oxide film 44 and a second iridium film 46.

The base substrate 10 includes a substrate. The substrate may be formed from an element semiconductor such as silicon, germanium or the like, a semiconductor substrate composed of compound semiconductor such as GaAs, ZnSe or the like, a metal substrate composed of Pt or the like, a sapphire substrate, or a dielectric substrate composed of MgO, SrTiO₃, BaTiO₃, glass or the like. Also, the base substrate 10 may include a single transistor or a plurality of transistors on the substrate. The transistor may include impurity regions that define a source region or a drain region, a gate dielectric layer and a gate electrode. An element isolation region may be formed between the transistors, whereby electrical insulation between the transistors can be achieved.

The TiAlN film 12 is formed on the base substrate 10. The TiAlN film 12 is composed of nitride of titanium and aluminum (TiAlN), and has an oxygen barrier function. Also, the TiAlN film 12 has a face-centered cubic type crystal structure, and is preferentially oriented in a (200) plane. It is noted that the “preferentially oriented” state means a state in which the diffraction peak from the (200) plane is greater than diffraction peaks from other crystal planes in θ-2θ scanning of the X-ray diffraction method.

The first electrode 20 is formed on the TiAlN film 12. The first electrode 20 may be composed of metal having a face-centered cubic type crystal structure, and may be formed from a film of metal selected from, for example, the group of Pt, Ir and Ru, or an alloy composed of two or more metals selected from the group of Pt, Ir and Ru. The first electrode 20 may be formed from a single layer or a laminate of multiple laminated layers, and the topmost layer of the first electrode 20 may preferably have a face-centered cubic type crystal structure, and may be preferentially oriented in a (111) plane, and its (100) plane may be exposed. Therefore, the first electrode 20 would have irregularities at its surface. This state is described with reference to FIG. 2.

FIG. 2 is a figure showing a unit lattice of a face-centered cubic type crystal structure. In the unit lattice, a (111) plane corresponds to a plane A shown in FIG. 2. At the topmost layer of the first electrode 20, the (111) plane is preferentially oriented, and therefore has a crystal structure in which the plane A is in parallel with a surface of the substrate. Further, the (100) plane that is exposed at the surface of the topmost layer of the first electrode 20 corresponds to a plane B shown in FIG. 2. In other words, as shown in FIG. 3, the plane A ((111) plane) is preferentially oriented, and therefore when its crystal lattice is maintained, the plane B ((100) plane) would not become aligned in parallel with the surface of the base substrate. As a result, as shown in FIG. 3, irregularities are generated geometrically in the surface of the topmost layer of the first electrode 20.

As described above, although the topmost layer of the first electrode 20 would have irregularities at its surface, its arithmetical mean roughness (Ra) may preferably be 1.5 nm or greater but 5 nm or smaller. Advantages of this case in which the arithmetical mean roughness of the topmost layer of the first electrode 20 in accordance with the present embodiment is in the aforementioned range are describe below.

In the present embodiment, the first electrode 20 includes a first iridium film 22, a first iridium oxide film 24 and a first platinum film 26, wherein its topmost layer is the first platinum film 26. In other words, the first platinum film 26 may be preferentially oriented in the (111) plane, and its (100) plane may preferably be exposed.

The dielectric film 30 is formed on the first electrode 20, in other words, on the first platinum film 26. The dielectric film 30 may be composed of oxide having a perovskite type crystal structure. Above all, the oxide may preferably be dielectric compound that is expressed by a general formula of AB_{1-X} C_{X} O₃, where the element A is at least Pb, the element B may be composed of at least one of Zr, Ti, V, W and Hf, and the element C may be composed of at least one of La, Sr, Ca and Nb. The dielectric film 30 may be preferentially oriented in a (111) plane in order to draw out good polarization characteristics.

The second electrode 40 is formed on the dielectric film 30. The second electrode 40 may be composed of, for example, precious metal such as Pt, Ir or the like, or its oxide (for example, IrOₓ or the like). The second electrode 40 may be formed from a single layer of the aforementioned material or may have a multilayer structure of laminated layers of plural materials.

In the present embodiment, the second electrode 40 has a second platinum film 42, a second iridium oxide film 44 and a second iridium film 46, and may be formed with the same materials used for the first iridium film 22, the first iridium oxide film 24 and the first platinum film 26, respectively.

Next, a method for manufacturing the dielectric capacitor 100 is described. First, a base substrate 10 is prepared. As the base substrate 10, one of the base substrates described above may be used. Then, a TiAlN film 12 is formed on the base substrate 10. The TiAlN film 12 may be formed by, for example, a sputtering method or a CVD method. The film forming condition is not particularly limited as long as the TiAlN film 12 can be preferentially oriented in a (200) plane. For example, when the film is formed by a sputter method, a mixed gas of argon and nitrogen gas may be used as the gas for processing, and the amount of nitrogen in the mixed gas may be adjusted to make the TiAlN film 12 to be preferentially oriented in a (200) plane.

The substrate temperature at the time of forming the TiAlN film 12 may preferably be 100-450° C., as it is to be preferentially oriented in the (200) plane. Also, as a preferred ratio of constituent metal elements, the TiAlN film 12 may include 50 atom % or more titanium, and may preferably include 50-70 atom % titanium and 30-50 atom % aluminum. It is noted that when a titanium aluminum layer includes 50 atom % or more titanium, the TiAlN film 12 having the (200) orientation can be obtained in a nitrization step to be described below.

Next, a first electrode 20 is formed on the TiAlN film 12. Concretely, a first iridium film 22, a first iridium oxide film 24 and a first platinum film 26 are sequentially formed. As the film forming method for forming the first iridium film 22 and the first iridium oxide film 24, any appropriate method may be selected depending on their materials. For example, a sputter method, a vacuum vapor deposition method, or a CVD method may be applied. The first iridium film 22, the first iridium oxide film 24 and at least a part of the first platinum film 26 can be preferentially oriented in a (111) plane.

It is noted that the first platinum film 26, the topmost layer of the first electrode 20, may preferably be formed such that its (100) plane is exposed. In order to form the first platinum film 26 in a manner to expose its (100) plane, a platinum film is first formed by a physical vapor phase deposition method (PVD method). In this instance, the platinum film is formed while controlling the kinetic energy of metal atoms that are sputtered, thereby controlling the migration energy of the atoms to be within a desired range. As a method for controlling the kinetic energy, the following measures may be enumerated.

As a first measure, the application voltage at the time of sputtering may be set to 400 V or lower, and more preferably to 300 V or higher but 400 V or lower. When the application voltage is 400 V or lower, the kinetic energy can be made smaller, and therefore the migration energy can be appropriately adjusted. By this, crystals can be slowly grown, and a platinum film having a desired crystal structure can be formed. However, the application voltage is preferably 300 V or higher, because the sputter discharge becomes unstable when it is less than 300 V.

As a second measure, the degree of vacuum at the time of film formation may be set to 0.8 Pa or higher but 10 Pa or lower. When the degree of vacuum is lower than 0.8 Pa, it is not possible to form a platinum film whose arithmetical mean roughness of its surface is 1.5 nm or higher but 5 nm or lower. When the kinetic energy becomes greater, the migration energy becomes greater, such that crystallization occurs in an orientation that is more stable than the desired crystal structure. The degree of vacuum higher than 10 Pa is not preferred as the sputter discharge becomes unstable.

As a third measure, the platinum film may be formed under a condition in which the film forming rate of the platinum film is 0.5 Å or greater but 5 Å or lower, and more preferably 1.0 Å or greater but 5 Å or lower. When the film forming rate is less than 0.5 Å, the time required for film growth becomes too long, which may lead to an increase in the manufacturing cost. When the film forming rate is greater than 5 Å, it is not possible to form a platinum film whose arithmetical mean roughness at its surface is 1.5 nm or higher but 5 nm or lower. Besides the first and second measures, the film forming rate may be controlled by appropriately adjusting the distance between the target and the substrate.

According to the method for forming the platinum film 26 in accordance with the present embodiment, the kinetic energy may be controlled through combining at least one of the aforementioned first—third measures, whereby the migration energy at the time of formation of the platinum film can be brought in a desired range.

Next, a dielectric film 30 is formed on the first electrode 20. An appropriate film forming method for forming the dielectric film 30 may be selected depending on the material of the dielectric film. For example, a solution coating method (including a sol-gel method, and a MOD (metal organic decomposition) method), a sputter method, a CVD method, or a MOCVD (metal organic chemical vapor deposition) method may be applied.

Then, a second electrode 40 is formed on the dielectric film 30. Concretely, a second platinum film 42, a second iridium oxide film 44 and a second iridium film 46 are sequentially formed. As a method for forming the film, the film forming method similar to the method applied for forming the first electrode 20 can be used.

Through the steps described above, the dielectric capacitor 100 in accordance with the present embodiment is manufactured.

In the dielectric capacitor 100 in accordance with the present embodiment, the TiAlN film 12 has a face-centered cubic type crystal structure, and preferentially oriented in the (200) plane. By this, the degree of orientation of the dielectric film 30 in the (111) plane can be improved, and the dielectric capacitor 100 can be provided with an excellent hysteresis characteristic.

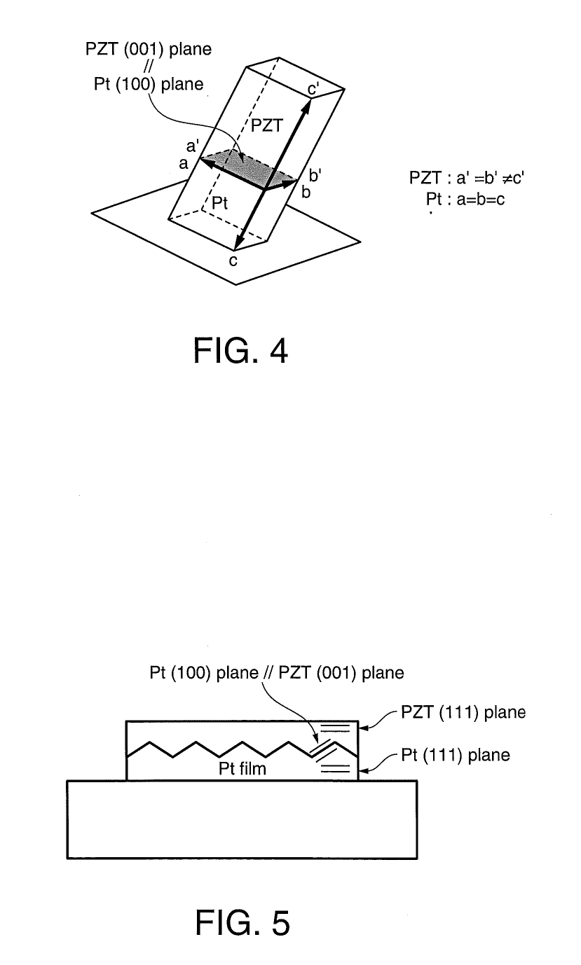

In the dielectric capacitor 100 in accordance with the present embodiment, the first electrode 20 has its (111) plane being preferentially oriented, and its (100) plane that is not in parallel with the surface of the base substrate 10 is exposed at its surface such that the surface of the first electrode 20 has irregularities. FIG. 4 shows in enlargement a boundary between the first electrode 20 and the dielectric film 30. As shown in FIG. 4, the crystal system of the first electrode 20 is in a face-centered cubic type, and three sides of the crystal lattice have the same length (a=b=c). On the other hand, in the case of a PZT film having a tetragonal system crystal structure, three sides of the crystal lattice are not in the same length, and are in a relation of a=b≠c. In the dielectric capacitor 100 in accordance with the present embodiment, the (100) plane exposed at the surface of the first electrode 20 and the (001) plane of the PZT film can be crystallized in a lattice-matched manner. As a result, as shown in FIG. 5, the PZT film becomes preferentially oriented in the (111) plane due to the geometrical relation between the first electrode 20 and the PZT film.

As a result, the dielectric film 30 can be strongly preferentially oriented in the (111) plane, such that the dielectric capacitor 100 can be provided with an excellent hysteresis characteristic.

According to the present embodiment, the dielectric film 30 that is preferentially oriented in the (111) plane can be formed not only in a PZT film of the tetragonal crystal system but also in a PZT film of a rhombohedral crystal type. According to the dielectric capacitor 100 in accordance with the present embodiment, the dielectric film 30 preferentially oriented in the (111) plane can be formed, as described above, and the capacitor 100 with a good hysteresis characteristic can be provided.

### 2. EXPERIMENTAL EXAMPLES

### 2.1. Experimental Example 1

An experimental example 1 of a dielectric capacitor in accordance with of the present embodiment is described below. In the experimental example 1, a TiAlN film 12 was formed to be preferentially oriented in a (200) plane, and a first platinum film 26 was formed in a manner that its (100) plane that is not in parallel with the surface of a base substrate 10 was exposed.

First, as the base substrate 10, a silicon substrate was prepared. On the base substrate 10, a TiAlN film 12 having a film thickness of 100 nm, a first iridium film 22 having a film thickness of 100 nm and a first iridium oxide film 24 having a film thickness of 30 nm were sequentially laminated. These films were formed by a sputter method. Then, a first platinum film 26 having a film thickness of 100 nm was formed on the first iridium oxide film 24, thereby forming a first electrode 20 composed of the three types of laminated films. The forming condition for each of the films is described below.

The TiAlN film 12 was formed, using a Ti—Al alloy target (composed of 60 atom % Ti and 40 atom % Al), in a mixed gas atmosphere of argon (Ar) and nitrogen (N₂) by a DC magnetron sputter method, at a substrate temperature of 250° C., with the flow quantity of Ar being 10 sccm and the flow quantity of N₂ being 40 sccm.

The first iridium film 22 was formed, using an Ir target, in an Ar atmosphere by a DC magnetron sputter method, at a substrate temperature of 250° C., with the flow quantity of Ar being 90 sccm.

The first iridium oxide film 24 was formed, using an Ir target, in a mixed gas atmosphere of Ar and oxygen (O₂) by a DC magnetron sputter method, at a substrate temperature of 250° C., with the flow quantity of Ar being 45 sccm and the flow quantity of O₂ being 35 sccm.

The first platinum film 26 was formed, using a Pt target, by a DC magnetron sputter method, at a substrate temperature of 200° C., with the flow quantity of Ar being 94 sccm, the discharge voltage being 311V, the film forming rate being 2.9 Å/sec, and the process pressure being 4.8 Pa.

Next, a PZT film as a dielectric film 30 (hereafter referred to as a “PZT film 30”) was formed on the first platinum film 26. The PZT film 30 was formed through repeating the steps of coating a sol-gel solution of PZT by a spin coat method and drying the same three times, and then, the coated layer was crystallized by conducting a rapid thermal annealing (RTA) treatment. The crystallization temperature was 600° C., the time for crystallization was 5 minutes, and the atmosphere for the treatment was oxygen. The PZT film after crystallization had a film thickness of 150 nm.

Then, a second platinum film 42 having a thickness of 50 nm as a second electrode 40, a second iridium oxide film 44 having a thickness of 100 nm and a second iridium film 46 having a thickness of 70 nm were formed on the dielectric film 30. Film forming methods and conditions that are generally the same as those applied for forming the first platinum film 26, the first iridium oxide film 24 and the first iridium film 22 described above were used. Then, by conducting known photolithography and etching technique, a dielectric capacitor 100 shown in FIG. 1 was formed.

### 2.2. Experimental Example 2

An experimental example 2 of a dielectric capacitor in accordance with of the present embodiment is described below. In the experimental example 2, a TiAlN film 12 was formed to be preferentially oriented in a (111) plane, and a first platinum film 26 was formed in a manner that its (100) plane that is not in parallel with the surface of a base substrate 10 was exposed.

First, as the base substrate 10, a silicon substrate was prepared. On the base substrate 10, a TiAlN film 12 having a film thickness of 100 nm, a first iridium film 22 having a film thickness of 100 nm and a first iridium oxide film 24 having a film thickness of 30 nm were sequentially laminated. These films were formed by a sputter method. Then, a first platinum film 26 having a film thickness of 100 nm was formed on the first iridium oxide film 24, thereby forming a first electrode 20 composed of the three types of laminated films. The forming condition for each of the films is described below.

The TiAlN film 12 was formed, using a Ti—Al alloy target (composed of 60 atom % Ti and 40 atom % Al), in a mixed gas atmosphere of argon (Ar) and nitrogen (N₂) by a DC magnetron sputter method, at a substrate temperature of 400° C., with the flow quantity of Ar being 45 sccm and the flow quantity of N₂ being 5 sccm.

The first iridium film 22 was formed, using an Ir target, in an Ar atmosphere by a DC magnetron sputter method, at a substrate temperature of 250° C., with the flow quantity of Ar being 90 sccm.

The first iridium oxide film 24 was formed, using an Ir target, in a mixed gas atmosphere of Ar and oxygen (O₂) by a DC magnetron sputter method, at a substrate temperature of 250° C., with the flow quantity of Ar being 45 sccm and the flow quantity of O₂ being 35 sccm.

The first platinum film 26 was formed, using a Pt target, by a DC magnetron sputter method, at a substrate temperature of 200° C., with the flow quantity of Ar being 94 sccm, the discharge voltage being 311V, the film forming rate being 2.9 Å/sec, and the process pressure being 4.8 Pa.

Next, a PZT film as a dielectric film 30 (hereafter referred to as a “PZT film 30”) was formed on the first platinum film 26. The PZT film 30 was formed through repeating the steps of coating a sol-gel solution of PZT by a spin coat method and drying the same three times, and then, the coated layer was crystallized by conducting a rapid thermal annealing (RTA) treatment. The crystallization temperature was 600° C., the time for crystallization was 5 minutes, and the atmosphere for the treatment was oxygen. The PZT film after crystallization had a film thickness of 150 nm.

Then, a second platinum film 42 having a thickness of 50 nm as a second electrode 40, a second iridium oxide film 44 having a thickness of 100 nm and a second iridium film 46 having a thickness of 70 nm were formed on the dielectric film 30. Film forming methods and conditions that are generally the same as those applied for forming the first platinum film 26, the first iridium oxide film 24 and the first iridium film 22 described above were used. Then, by conducting known photolithography and etching technique, a dielectric capacitor 100 shown in FIG. 1 was formed.

### 2.3. Experimental Example 3

### Comparison Example

An experimental example 3 of a dielectric capacitor for comparison with the present embodiment is described below. In the experimental example 3, a TiAlN film 12 was formed to be preferentially oriented in a (111) plane, and a first platinum film 26 was formed in a manner that its (100) plane that is not in parallel with the surface of a base substrate 10 was not exposed.

First, as the base substrate 10, a silicon substrate was prepared. On the base substrate 10, a TiAlN film 12 having a film thickness of 100 nm, a first iridium film 22 having a film thickness of 100 nm and a first iridium oxide film 24 having a film thickness of 30 nm were sequentially laminated. These films were formed by a sputter method. Then, a first platinum film 26 having a film thickness of 100 nm was formed on the first iridium oxide film 24, thereby forming a first electrode 20 composed of the three types of laminated films. The forming condition for each of the films is described below.

The TiAlN film 12 was formed, using a Ti—Al alloy target (composed of 60 atom % Ti and 40 atom % Al), in a mixed gas atmosphere of argon (Ar) and nitrogen (N₂) by a DC magnetron sputter method, at a substrate temperature of 400° C., with the flow quantity of Ar being 45 sccm and the flow quantity of N₂ being 5 sccm.

The first iridium film 22 was formed, using an Ir target, in an Ar atmosphere by a DC magnetron sputter method, at a substrate temperature of 250° C., with the flow quantity of Ar being 90 sccm.

The first iridium oxide film 24 was formed, using an Ir target, in a mixed gas atmosphere of argon (Ar) and oxygen (O₂) by a DC magnetron sputter method, at a substrate temperature of 250° C., with the flow quantity of Ar being 45 seem and the flow quantity of O₂ being 35 seem.

The first platinum film 26 was formed, using a Pt target, by a DC magnetron sputter method, at a substrate temperature of 200° C., with the flow quantity of Ar being 94 seem, the discharge voltage being 435V, the film forming rate being 6.0 Å/sec, and the process pressure being 0.25 Pa.

Next, a PZT film as a dielectric film 30 (hereafter referred to as a “PZT film 30”) was formed on the first platinum film 26. The PZT film 30 was formed through repeating the steps of coating a sol-gel solution of PZT by a spin coat method and drying the same three times, and then, the coated layer was crystallized by conducting a rapid thermal annealing (RTA) treatment. The crystallization temperature was 600° C., the time for crystallization was 5 minutes, and the atmosphere for the treatment was oxygen. The PZT film after crystallization had a film thickness of 150 nm.

Then, a second platinum film 42 having a thickness of 50 nm as a second electrode 40, a second iridium oxide film 44 having a thickness of 100 nm and a second iridium film 46 having a thickness of 70 nm were formed on the dielectric film 30. Film forming methods and conditions that are generally the same as those applied for forming the first platinum film 26, the first iridium oxide film 24 and the first iridium film 22 described above were used. Then, by conducting known photolithography and etching technique, a dielectric capacitor 100 shown in FIG. 1 was formed.

### 2.4. Evaluation 1

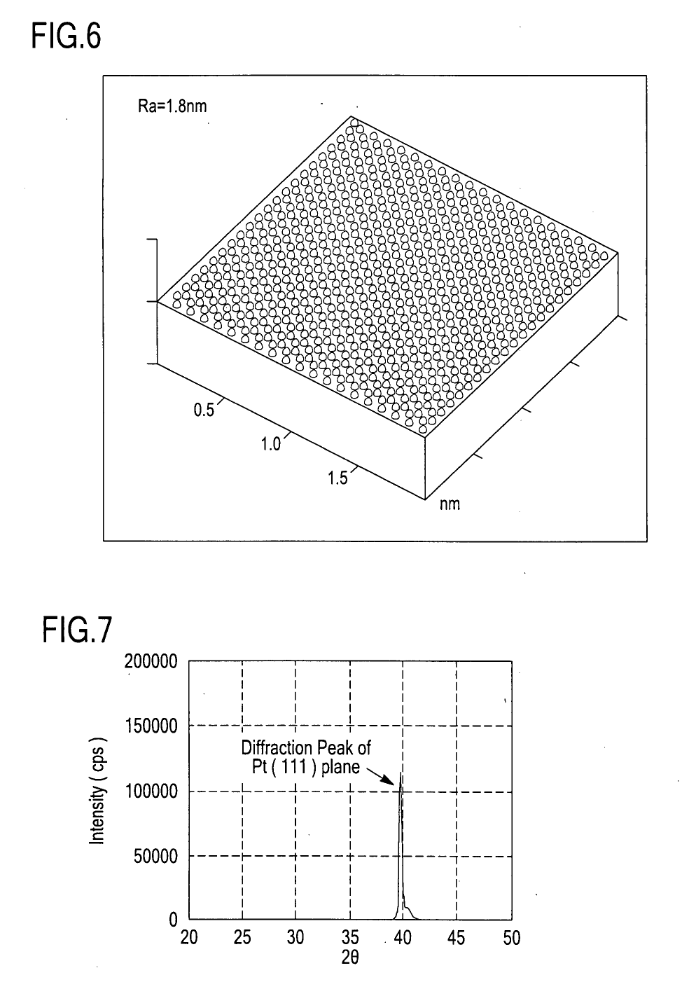

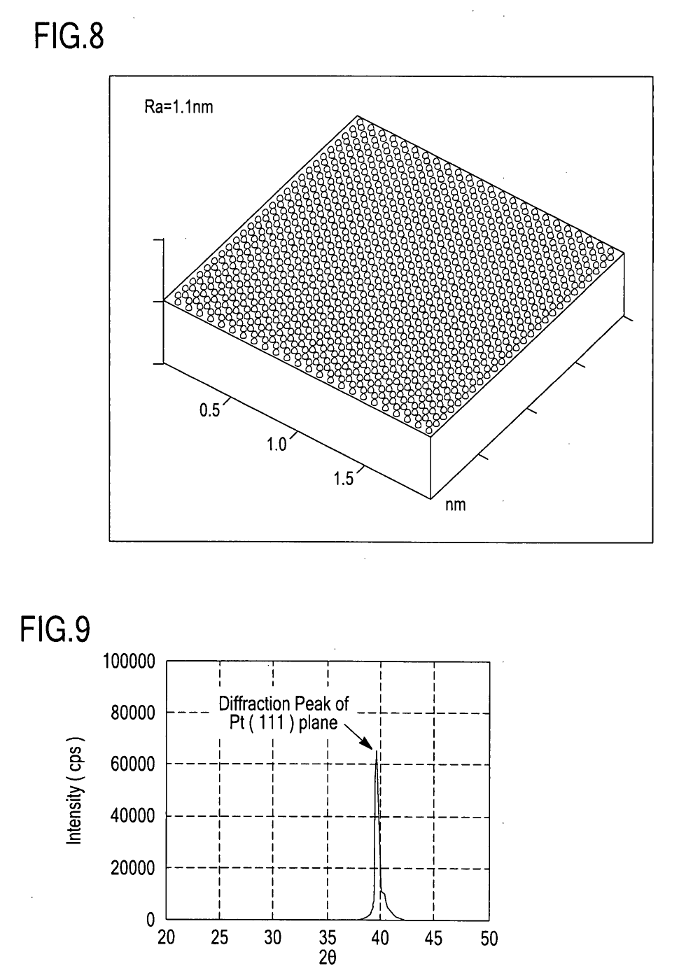

First, when the first electrodes 20 were formed, the surface configuration of each of the first electrodes 20 was examined by an atomic force microscope (AFM). The AFM observation was conducted with the measurement mode being a tapping mode, the probe scanning speed being 1 Hz, and the horizontal resolution being 9 bits. An AFM image of the surface of the first electrode 20 of the experimental example 1 is shown in FIG. 6. Further, the crystal structure and orientation of the first electrode 20 were examined by an X-ray diffraction (XRD) method. An XRD pattern of the first electrode 20 of the experimental example 1 is shown in FIG. 7. For comparison, an AFM image of the surface of the first electrode 20 of the experimental example 3 is shown in FIG. 8, and its XRD pattern is shown in FIG. 9.

It is observed from FIG. 6 that the surface of the first platinum film 26 of the first electrode 20 of the experimental example 2 had irregularities, and the arithmetical mean roughness of the surface of the film was 1.8 nm. Also, as observed from FIG. 7, it was confirmed that the first platinum film 26 of the experimental example 2 was strongly oriented in a (111) plane.

In contrast, as it is clear from comparison between FIG. 6 and FIG. 8, the surface of the first platinum film 26 of the first electrode 20 of the experimental example 3 had smaller irregularities, and its arithmetical mean roughness Ra was 1.1 nm. Also, as shown in FIG. 9, the first platinum film 26 was oriented in a (111) plane, but the diffraction peak intensity from the (111) plane was smaller than that of the first platinum film 26 of the experimental example 2, and it was therefore confirmed that the degree of (111) orientation was weak.

### 2.5. Evaluation 2

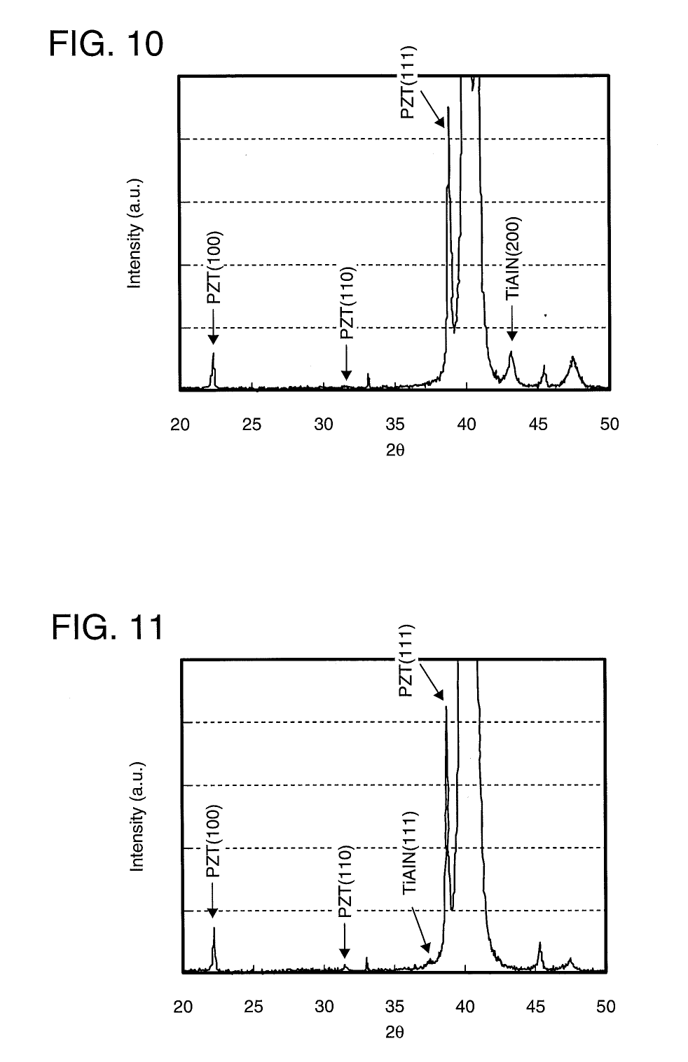

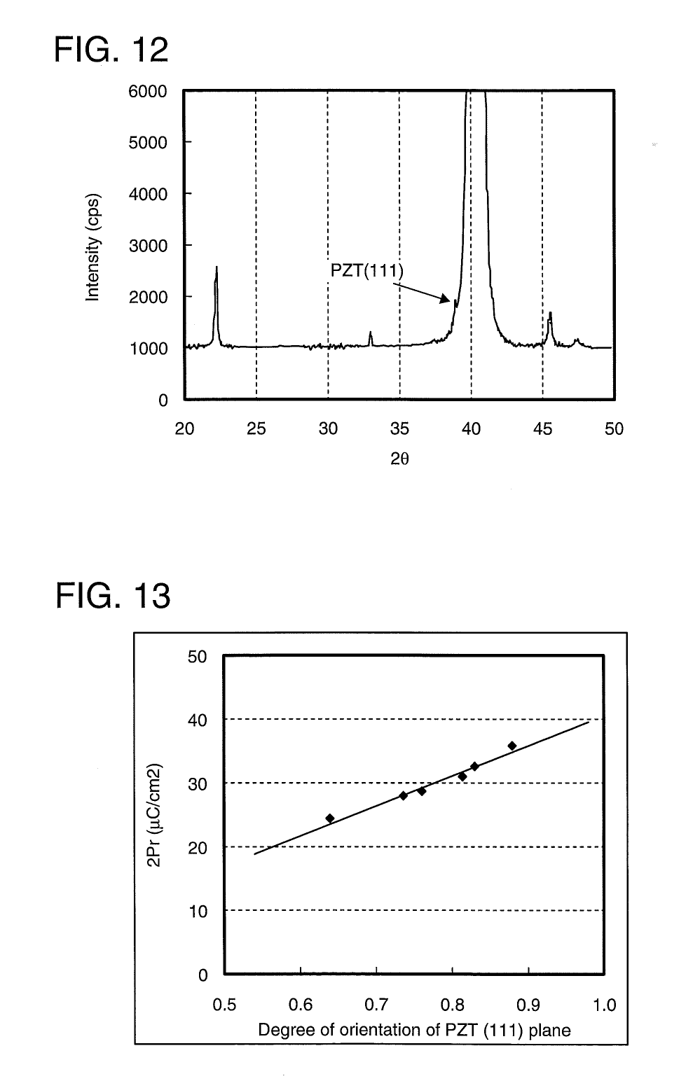

Next, XRD patterns of the PZT films were obtained when the dielectric films 30 of the experimental examples 1-3 were formed. FIG. 10 shows the XRD pattern of the PZT film of the experimental example 1. FIG. 11 shows the XRD pattern of the PZT film of the experimental example 2. FIG. 12 shows the XRD pattern of the PZT film of the experimental example 3.

In FIG. 10-FIG. 12, a peak near 2θ=38.5° is assumed to indicate crystalline PZT having a (111) orientation. A peak near 2θ=22.0° is assumed to indicate crystalline PZT having a (100) orientation. A peak near 2θ=32.0° is assumed to indicate crystalline PZT having a (110) orientation. A peak near 2θ=43.0° is assumed to indicate crystalline TiAlN having a (200) orientation. A peak near 2θ=37.5° is assumed to indicate crystalline TiAlN having a (111) orientation.

Degrees of orientation of the (111) plane of the PZT films were calculated with the results in FIGS. 10-12. A degree of orientation can be defined by the following formula.

Degree of orientation of PZT (111) plane=PZT (111) peak intensity/{PZT (100) peak intensity+PZT (110) peak intensity+PZT (111) peak intensity}

The degree of orientation of the (111) plane of the PZT film of the experimental example 1 was 0.88, the degree of orientation of the (111) plane of the PZT film of the experimental example 2 was 0.83, and the degree of orientation of the (111) plane of the PZT film of the experimental example 3 was 0.37. Accordingly, it was confirmed that the PZT film 30 of the dielectric capacitor 100 that included the crystalline TiAlN having a (200) orientation below the first electrode 20, and in which the first platinum film 26 was formed in a manner that its (100) plane that was not in parallel with the surface of the base substrate 10 was exposed, had a higher degree of orientation of the (111) plane.

Further, it was confirmed, as indicated in FIG. 13, that the degree of orientation of the (111) plane of the PZT film 30 and the remanent polarization density of the dielectric capacitor were in a proportional relation. Accordingly, by the dielectric capacitor 100 in accordance with the present embodiment, its hysteresis characteristic can be made excellent, and the output voltage of the dielectric memory using the dielectric capacitor 100 can be increased, such that its reliability can be improved, and a higher level of integration can be achieved.

### 2.6. Evaluation 3

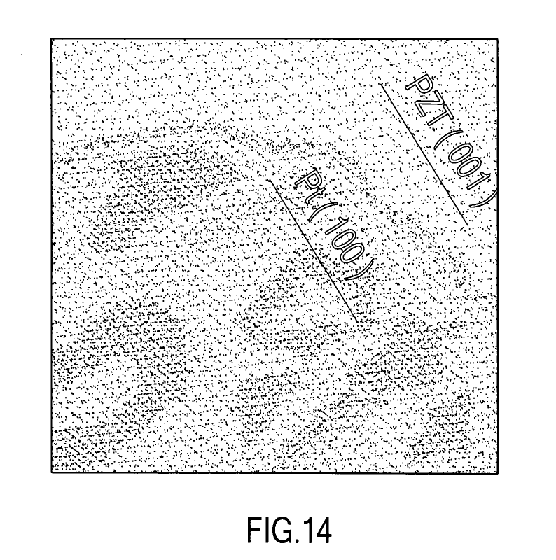

Also, the atomic arrangement at an interface between the first electrode 20 and the PZT film 30 of the experimental example 1 was observed by an electron microscope, and its result is shown in FIG. 14. As observed in FIG. 14, it was confirmed that the (100) plane of the first platinum film 26 and the (001) plane of the PZT film 30 were lattice-matched to each other. For this reason, the PZT film 30 in accordance with the present embodiment example can geometrically have a strong preferential orientation in the (111) plane. As the first platinum film 26 has its (111) plane preferentially oriented, and its (100) plane that is not in parallel with the surface of the base substrate 10 is exposed at its surface, its surface has irregularities. Also, the dielectric film of the dielectric capacitor in accordance with the present embodiment example is a film that has a perovskite type crystal structure, and is preferentially oriented in the (111) plane. Further, the (100) plane that is exposed at the surface of the electrode and the (001) plane of the dielectric film are lattice-matched to each other.

As described above, by the method for manufacturing the dielectric capacitor 100 in accordance with the present embodiment, the crystal orientation of the PZT film can be improved. As a result, a dielectric capacitor with a large amount of remanent polarization can be obtained.

### 3. Application Example

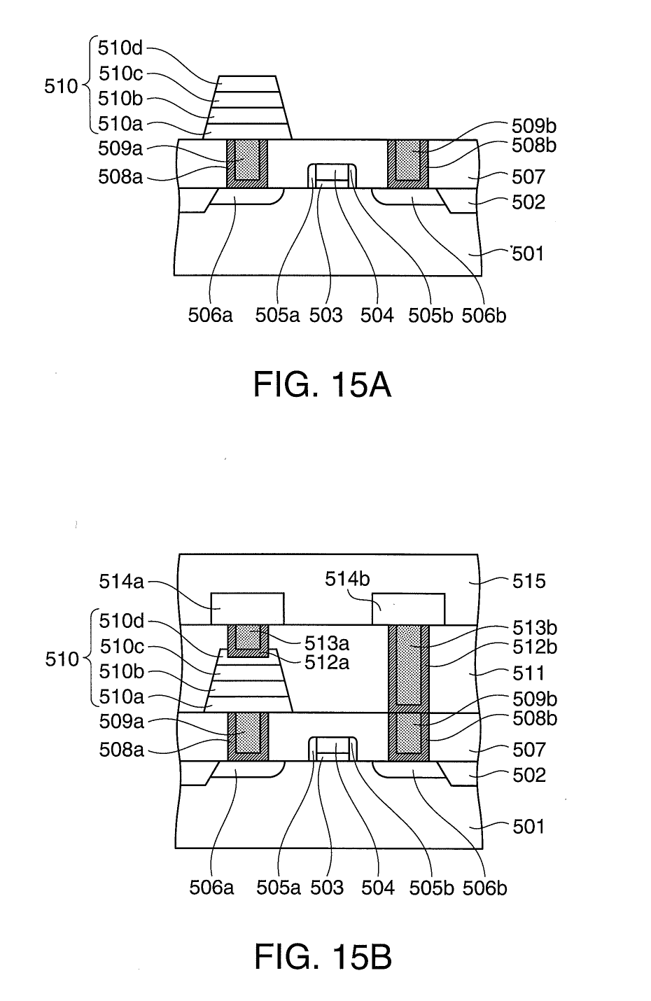

Next, a manufacturing process and a structure of an example of semiconductor device including a dielectric capacitor in accordance with an embodiment of the invention are described with reference to FIGS. 15A and 15B. It is noted that, in the present embodiment, a ferroelectric memory device including a dielectric capacitor is described as an example. FIGS. 15A and 15B are cross-sectional views for describing the semiconductor device in accordance with the application example.

As shown in FIG. 15A, a MOS transistor is formed on a silicon substrate 501 that is a semiconductor layer. An example of the process is described below. First, an element isolation film 502 for defining an active region is formed in the silicon substrate 501. Then, a gate oxide film 503 is formed in the defined active region. A gate electrode 504 is formed on the gate oxide film 503, sidewalls 505a and 505b are formed on side walls of the gate electrode 504, and impurity regions 506a and 506b that form a source and a drain are formed in the silicon substrate 501 that is located at a device region. In this manner, the MOS transistor is formed in the silicon substrate 501.

Next, a first interlayer dielectric film 507 composed of silicon oxide as a principle constituent is formed on the MOS transistor, and contact holes that connect to the impurity regions 506a and 506b are further formed in the first interlayer dielectric film 507. Adhesion layers 508a and 508b, and W plugs 509a and 509b are embedded in the contact holes. Then, a ferroelectric capacitor 510 that is connected to the W plug 509a is formed on the first interlayer dielectric film 507.

The ferroelectric capacitor 510 has a structure in which a lower electrode 510a, a ferroelectric layer 510b, an upper electrode 510c, and a protection film 510d are laminated in this order. The ferroelectric capacitor 510 may be formed by a film forming method as follows. As the lower electrode 510a, a TiAlN film (100 nm in thickness), an Ir film (100 nm in thickness) and an IrOx film (30 nm in thickness) are formed by a sputter method in this order, and further a Pt film (100 nm in thickness) is formed by the method in accordance with the invention. As the ferroelectric layer 510b, a PZT layer is formed by repeating the steps of coating a sol-gel solution of PZT by a spin coat method and drying the same three times, and then the coated layer was crystallized by conducting a rapid thermal annealing (RTA) treatment. The crystallization temperature is 600° C., the time for crystallization is 5 minutes, and the atmosphere for the treatment is oxygen. The PZT film after crystallization has a film thickness of 150 nm. As the upper electrode 510c, a Pt film (50 nm in thickness) is formed. Then, a heat treatment is conducted at 700° C. for one hour in an oxygen atmosphere, and further an IrOx film (100 nm in thickness) and an Ir film (70 nm in thickness) are formed thereon in this order as the protection film 510d. Then, known photolithography and etching techniques are conducted, thereby forming the ferroelectric capacitor 510.

Then, as shown in FIG. 15B, a second interlayer dielectric film 511 composed of silicon oxide as a principle constituent is formed on the ferroelectric capacitor 510, and a via hole located above the ferroelectric capacitor 510 and a via hole located above the W plug 509b are formed. An adhesion layer 512a and a W plug 513a connected to the ferroelectric capacitor 510, and an adhesion layer 512b and a W plug 513b connected to the W plug 509 are embedded in these via holes. Al alloy wirings 514a and 514b connected respectively to the W plugs 513a and 513b are formed on the second interlayer dielectric film 511. Then, a passivation film 515 is formed on the second interlayer dielectric film 511 and the Al alloy wirings 514a and 514b. In the ferroelectric memory device described above, the ferroelectric capacitor 510 uses the TiAlN film and the platinum film having desired orientations as the lower electrode 510a, and thus includes the PZT system dielectric film 510b that is strongly oriented in the (111) plane. For this reason, the ferroelectric capacitor 510 has an excellent hysteresis characteristic, and the ferroelectric memory device that is highly reliable can be provided.

Some embodiments of the invention are described above in detail. However, a person having an ordinary skill in the art should readily understand that many modifications can be made without departing in substance from the novel matter and effect of the invention. Accordingly, those modified examples are also deemed included in the scope of the invention.

What is claimed is:

1. A dielectric capacitor comprising:
a TiAlN film formed on a base substrate;
a first electrode formed above the TiAlN film;
a dielectric film formed above the first electrode; and
a second electrode formed above the dielectric film,
wherein the TiAlN film is crystalline, and has a (200) plane preferentially oriented in parallel with a surface of the base substrate.

2. A dielectric capacitor according to claim 1, wherein the dielectric film has a perovskite type crystal structure, and is preferentially oriented in a (111) plane.

3. A dielectric capacitor according to claim 1, wherein the dielectric layer is composed of dielectric expressed by a general formula of AB_{1-X} C_{X} O₃, where an element A is at least Pb, an element B is composed of at least one of Zr, Ti, V, W and Hf, and an element C is composed of at least one of La, Sr, Ca and Nb.

4. A dielectric capacitor according to claim 3, wherein the dielectric film is composed of lead zirconate titanate.

5. A dielectric capacitor according to claim 3, wherein the dielectric film is composed of lead zirconate titanate with at least one of La, Sr, Ca and Nb added therein.

6. A dielectric capacitor according to claim 1, wherein a topmost layer of the first electrode has a face-centered cubic type crystal structure and is preferentially oriented in a (111) plane.

7. A dielectric capacitor according to claim 6, wherein the conductive film has a (100) plane that is not in parallel with a surface of the base substrate, and the (100) plane is exposed at an interface between the first electrode and the dielectric.

8. A dielectric capacitor according to claim 7, wherein the (100) plane of the conductive film is lattice-matched to a (001) plane of the dielectric film.

9. A dielectric capacitor according to claim 1, wherein the first electrode includes a conductive film composed of at least one of iridium, iridium oxide and platinum.

10. A dielectric capacitor according to claim 9, wherein the first electrode include an iridium film formed on the TiAlN film, an iridium oxide film formed on the iridium film, and a platinum film formed on the iridium oxide film.
